(19) United States
(12) Patent Application Publication
(10) Pub. No.: US 2006/0251051 A1
(43) Pub. Date: Nov. 9, 2006

(54) Adapter for accessing cellular services from a non-cellular device

(76) Inventors: Yogesh B. Bhatt, Schaumburg, IL (US); Sanjay Gupta, Lakewood, IL (US); Balakumar Jagadesan, Glendale Heights, IL (US)

Correspondence Address: MOTOROLA INC, 600 NORTH US HIGHWAY 45, ROOM AS437, LIBERTYVILLE, IL, 60048-5343, US

(21) Appl. No.: 11/086,006

(22) Filed: Mar. 22, 2005

(51) Int. Cl. H04L 12/66

(52) U.S. Cl. 370/352

(57) ABSTRACT

An adaptation apparatus (123) for providing access to cellular services of a service manager (119) of a cellular network (103, 105, 109, 115) for a non-cellular device (121) via a packet data network (117). The adaptation apparatus (123) comprises a cellular module (211, 219) and a packet data module (213, 221). The cellular module (211, 219) is configured to convert between cellular protocol information of a cellular network (103, 105, 109, 115) and non-cellular protocol information of the non-cellular device (121). The packet data module (213, 221) is configured to adapt outgoing cellular protocol information, destined for the cellular network (103, 105, 109, 115), for transport by the packet data network (117), and identify incoming cellular protocol information received from the cellular network (103, 105, 109, 115) via the packet data network (117).

### FIELD OF THE INVENTION

The present invention relates generally to the field of voice and data communications over an Internet Protocol (“IP”) network. In particular, the present invention relates to an apparatus for voice over IP communication from a non-cellular device to a cellular communication network.

### BACKGROUND OF THE INVENTION

Existing systems are capable of communicating voice calls over digital communication networks, such an Internet Protocol (“IP”) network. For example, an analog phone may be coupled to a Voice over IP (“VoIP”) adapter that converts analog voice information into data packets for transmission over the IP network. Similarly, the VoIP adapter may convert data packets received from the IP network into analog voice information for the analog phone. Thus, conventional analog phones may be connected to IP networks for communication with other digital devices coupled to the IP network or other analog device of a public switch telephone network (“PSTN”) coupled to the IP network.

Wireless communication systems are capable of communicating voice and data calls over cellular communication networks, including networks that utilize a digital cellular protocol such as CDMA, TDMA, GSM, iDEN, GPRS, EDGE, UMTS, WCDMA and CDMA2000. Cellular networks and systems that utilize these digital cellular protocols may only interact with devices that are capable of communicating via these digital cellular protocols, i.e., wireless cellular handsets. Accordingly, there is a need for an adapter that permits non-cellular handsets to communicate with wireless communication systems so that users of the non-cellular handsets may have the option of communicating via these cellular network and systems without involving an intermediate gateway controller system in the cellular network infrastructure and, in addition, benefit from services provided by the wireless communication systems.

### BRIEF DESCRIPTION OF THE DRAWINGS

FIG. 1 is a block diagram representing a wireless communication system that may be adapted to operate in accordance with the preferred embodiments of the present invention.

FIG. 2 is a block diagram of exemplary components of the adapter of FIG. 1 in accordance with the present invention.

FIG. 3 is a block diagram of an exemplary embodiment of the adapter of FIG. 1 in accordance with the present invention.

FIG. 4 is a flow diagram representing an exemplary text or multimedia message (e.g. SMS) sending operation in accordance with the present invention.

FIG. 5 is a flow diagram representing an exemplary text or multimedia message (e.g. SMS) receiving operation in accordance with the present invention.

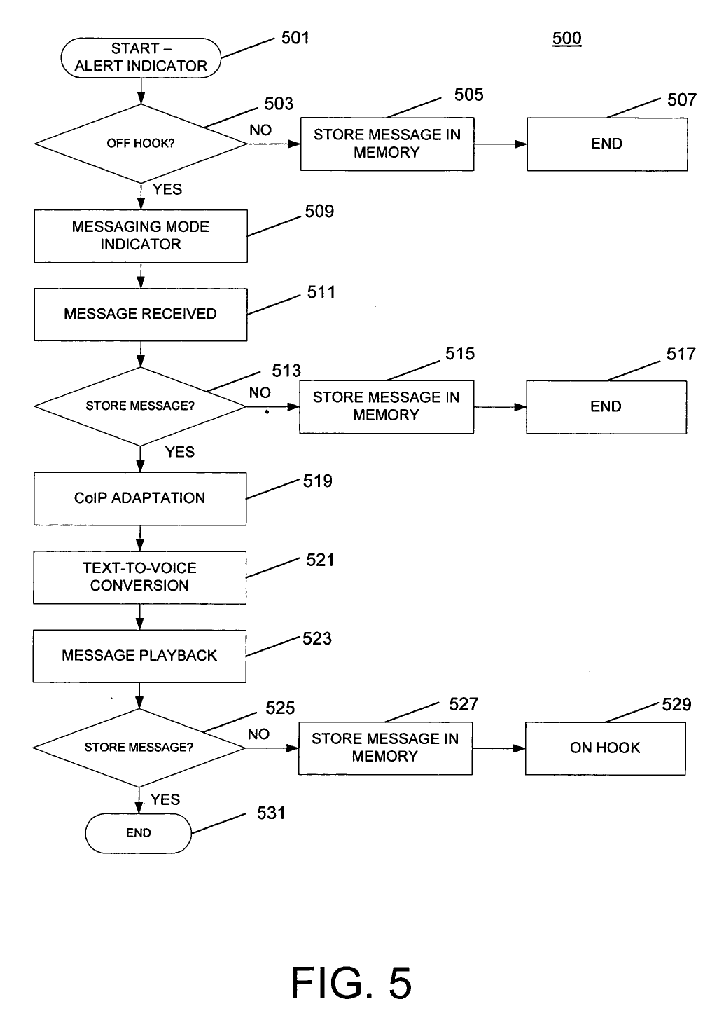

### DETAILED DESCRIPTION OF THE PREFERRED EMBODIMENTS

One aspect of the present invention is an adaptation apparatus for providing access to cellular services of a cellular network for a non-cellular device via a packet data network. The adaptation apparatus comprises a cellular module and a packet data module. The cellular module is configured to convert between cellular protocol information of a cellular network and non-cellular protocol information of the non-cellular device. The packet data module is configured to adapt outgoing cellular protocol information, destined for the cellular network, for transport by the packet data network, and identify incoming cellular protocol information received from the cellular network via the packet data network.

Another aspect of the present invention is a method for sending information from a non-cellular device to a cellular network. Non-cellular protocol information, such as a media message, is received from the non-cellular device. Examples of media message include text and multimedia messages. Next, the non-cellular protocol information is converted to cellular protocol information. The cellular protocol information is then adapted to one or more data packets for transport by a packet data network. Thereafter, the one or more data packets are directed to the cellular network via the packet data network.

A further aspect of the present invention is a method for receiving information at a non-cellular device from a cellular network. Cellular protocol information is received in the form of one or more data packets from the cellular network via a packet data network. Next, the cellular protocol information is adapted to a non-packetized form. The cellular protocol information in the non-packetized form is converted to non-cellular protocol information. Thereafter, the non-cellular protocol information is directed to the non-cellular device.

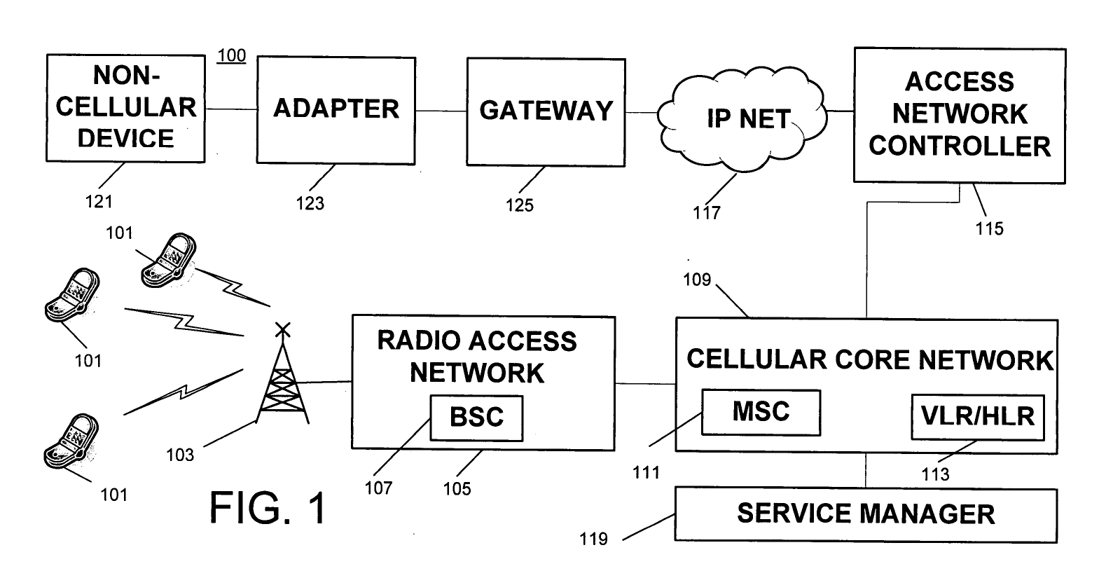

Referring to FIG. 1, there is provided a wireless communication system 100 that includes one or more mobile stations 101 and a wireless infrastructure, including one or more base transceiver stations (“BTS's”) 103, to provide a wireless voice and/or data link between the mobile stations and any other wired and wireless communication device. In addition to the BTS's 103, the wireless infrastructure may include a radio access network 105 which may include one or more base station controllers (“BSC's”) 107 coupled to some type of cellular core network 109, such as a visited public land mobile network (“VPLMN”) and/or a home public land mobile network (“HPLMN”). The cellular core network 109 may include one or more mobile switching centers (“MSC's”) 111 and/or one or more visitor location registers/home location registers (“VLR's/HLR's”) 113. Each BSC 107 controls communication among the BTS's 103, and manages the operation and interaction of the BTS's. The components of the cellular core network 109, including the MSC's 111 and the VLR's/HLR's 113, operate to route calls to and from the mobile station 101.

The wireless communication system 100 may utilize one or more types of wireless communication protocols for cellular-based communications. Examples of cellular-based communications include analog communications (using AMPS), digital communications (using CDMA, TDMA, GSM, iDEN, GPRS, or EDGE), and next generation communications (using UMTS or WCDMA). It is to be understood that other forms of wireless communication may also utilized for the present invention, for examples peer-to-peer or ad hoc communications including HomeRF, Bluetooth, IEEE 802.11 (a, b or g), and IEEE 802.16 (a, d, or e), without departing from the spirit and scope of the present invention.

The cellular core network 109 may include or be coupled to one or more access network controllers 115, such as a generic access network controller and/or an unlicensed mobile access (“UMA”) network controllers (“UNC”). Each access network controller 115 provides proper conversion of voice and/or data signals of the mobile stations 101 to and from another communication protocol, if necessary, and routes voice and/or data calls within the wireless communication system as well as to and from landline voice systems, such as a public switch telephone network (“PSTN”, not shown), and landline data systems, such as an Internet Protocol Network (“IP NET”) 117. For example, the access network controller 115 may convert wireless communication signals of the cellular core network 109 and digital data packets of the IP NET 117. Thus, each access network controller 115 utilizes protocols for voice or data traffic of the cellular core network 109 for handoff to a fixed-IP, such as the IP NET 117, or unlicensed spectrum network, such as WiFi and Bluetooth, and for routing back to the cellular core network.

The wireless communication system 100 may further include a service manager 119 for providing wireless communication services to the mobile stations 101. The service manager 119 may also provide wireless communication services to any other device communicating with the access network controller 115 and IP NET 117. For example, a non-cellular device coupled to the IP NET 117 may communicate with the access network controller 115 and the cellular core network 109, and may receive the benefit of services from the service manager 119 so long as a wireless communication protocol utilized and communicated over the IP NET. An example of a wireless communication service that may be provided by the service manager 119 is a messaging service, such as email service, short messaging service, instant messaging service, audio/image/video messaging services, and multimedia messaging service.

Still referring to FIG. 1, a non-cellular device 121 may communicate, through an adapter 123, to a gateway 125 to a packet data network, such as the IP NET 117. The non-cellular device 121 may be any type of communication device that is capable of being wired to a communication network, such as a PSTN, and communicating voice and/or data information with the communication network. For example, the non-cellular device 121 may be an analog phone having a RJ-11 connection port or a digital phone having an equivalent digital connection port. It is to be understood that, although the non-cellular device 121 is capable of communicating with a wired connection to the communication network, the non-cellular device 121 may have wireless functionality. For example, the non-cellular device 121 may be a cordless phone in which a base of the device is wired to the communication network. In order to provide communication capabilities of voice and data information, the non-cellular device 121 may include one or more output devices and one or more input devices. For example, the non-cellular device 121 may include a video output device such as a liquid crystal display and light emitting diode indicator, and/or an audio output device such as a speaker, alarm and/or buzzer. Likewise, by example, the non-cellular device 121 may include a video input device such as an optical sensor, an audio input device such as a microphone, and/or a mechanical input device such as a keyboard, keypad, and other touch or motion sensitive switches.

The gateway 125 may be any type of electronic component capable of receiving packet data and communicating the packet data over a packet data network, such as the IP NET 117. For example, the gateway may be a cable, satellite or DSL-type modem used to connect one or more appliances to the digital packet network.

The adapter 123 may be any type of electronic component that provides cellular communication capabilities over a packet data network. In particular, the adapter 123 provides cellular protocol information, i.e., cellular content and signaling, between the non-cellular device 121 and the gateway 125 by converting between native information of the non-cellular device 121 and the cellular protocol information adapted for transport over the packet data network of the gateway 125. The cellular over IP (“CoIP”) capabilities of the adapter may include, but are not limited to, CoIP signaling capabilities, CoIP speech bearer capabilities, CoIP physical layer capabilities, and CoIP service capabilities. For example, CoIP signaling capabilities may include translation between PSTN UNI to cellular over IP telephone and cellular interface standards as well as translation between the PSTN UNI signaling traffic to/from cellular and CoIP signaling. Examples of CoIP speech bearer capabilities may include converting G.711 CS codec to GSM codec and, then as an RTP-AMR packet stream. Examples of the CoIP physical layer capabilities include support for RJ-45 interface to gateway 125, wired or wireless, as well as support for RJ-11 connection to a PSTN phone and/or fax. Examples of CoP service capabilities may include porting cellular services to PSTN UNI, such as short messaging services, multimedia messaging services, instant messaging services, and presence services.

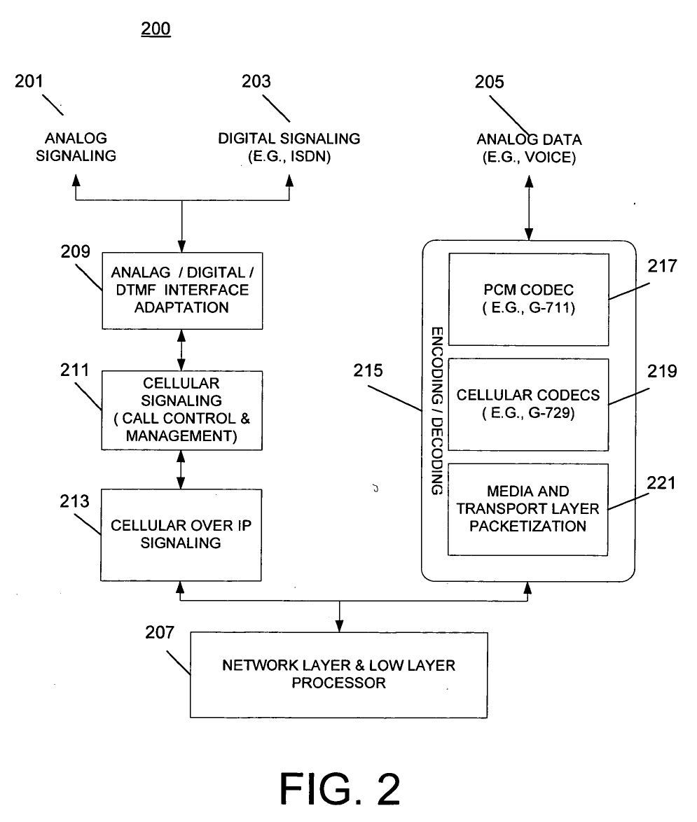

It is to be understood that, although FIG. 2 shows the non-cellular device 121, the adapter 123 and the gateway 125 as separate components, a single component may be separated into subcomponents or two or more of components may be combined without departing from the spirit and scope of the present invention.

FIG. 2 is a block diagram representing exemplary components 200 of the adapter 123, which processes between signaling and media information and network information. Examples of signaling information include analog signaling 201 and digital signaling 203, such ISDN information, and examples of media information include analog data 205, such as voice information. The network information is managed by a network layer & low layer processor 207 of the adapter 123 for communication to a packet data network, such as IP NET 117. The signaling information may be managed by signaling components, such as components 209, 211 & 213, and the media information may be processed by media components, such as encoding/decoding components 215.

The signaling components include an analog and/or digital DTMF interface adaption component 209, a cellular signaling component 211, and a cellular over IP signaling component 213. The DTMF interface adaption component 209 provides general signaling functions for dealing with analog and/or digital signaling. The cellular signaling component 211 provides call control and management functions including provisions for services by a cellular network. The cellular over IP signaling component 213 provides management of transporting cellular signaling over a packet data network. In particular, the cellular over IP signaling component 213 receives cellular signaling from the cellular signaling component 211 and adapts them for transport over the packet data network via the network layer & low layer processor 207 and, likewise, receives packet data information from the network layer & low layer processor and extract the cellular signaling from the packet data information for the cellular signaling component.

The media components, such as encoding/decoding components 215, include a PCM codec 217, a cellular codecs 219 and a media and transport layer packetization component 221. The PCM codec 217 provides general processing functions for dealing with analog data, such as voice information. The cellular codecs 219 manage coding and decoding of media information, to and from the PCM codec 217, based on a cellular protocol, such as G-729. The media and transport layer packetization component 221 provides management of converting the cellular protocol based media information to and from a packet data format. Thus, the media and transport layer packetization component 221 adapts the media information for transport over the packet data network via the network layer & low layer processor 207 and, likewise, receives packet data information from the network layer & low layer processor and extract the cellular protocol based media information from the packet data information for the cellular codecs 219.

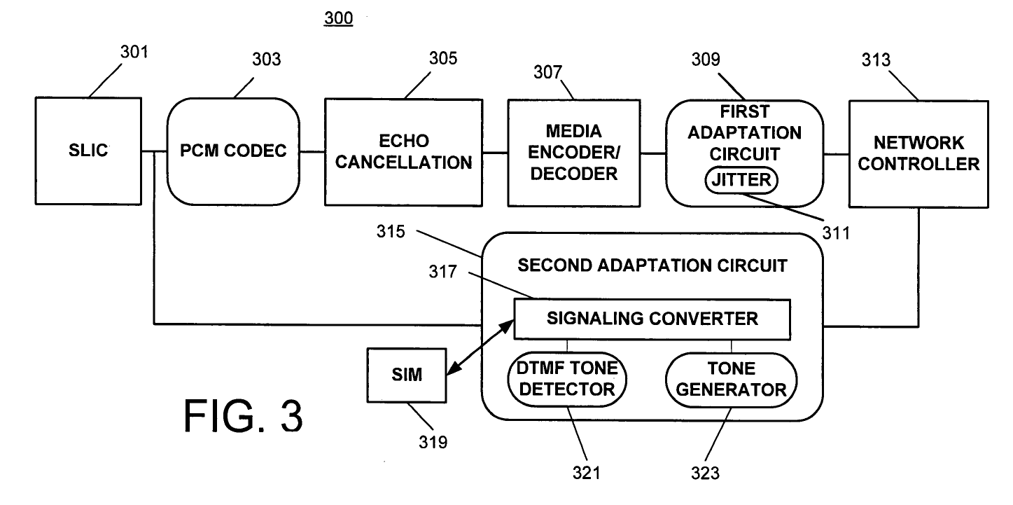

FIG. 3 is a block diagram of an exemplary embodiment 300 of the adapter 123. The exemplary embodiment 300 includes a subscriber-line interface card (SLIC) 301, a PCM codec 303, an echo cancellation 305, and a media encoder/decoder 307. The SLIC 301 provides, for example, an interface between the cellular core network 109 and the non-cellular device 121 to maintain compatibility with non-cellular device. Some of the key functions of the SLIC 301 include voltage adapting between an analog POTS line (On-hook/off-hook voltage variation) with the rest of the line interface; supervising the status of the subscriber line, such as ring signals; converting the voice and signaling traffic to corresponding voltage variations; and noise immunity. Key functions of the PCM codec 303 include, but are not limited to, filtering signals from SLIC 301 and converting them from analog to digital formats. For example, the PCM codec 303 may convert analog voice to a G.711 format, which is an international standard for encoding telephone audio on a 64 kbps channel. The PCM codec 303 may also convert to a speech codec G-729 format (8 kbps), which is similar to a toll-quality voice under clean channel conditions. The echo cancellation 305 handles silence frames and removes echo received from the packet data network. The media encoder/decoder 307 encodes from a cellular speech codec format to a packetized voice protocol format, for example, AMR/RTP/UDP. The media encoder/decoder 307 provides upstream indicators, such as time-stamp information, as well as compression, signal processing and encoding enhancements. In the reverse direction, the media encoder/decoder 307 provides voice play-out, jitter adjustment, re-ordering of packets, time-synchronization, and converts from packetized voice protocol formats to cellular codec format/PCM formats.

The exemplary embodiment 300 further includes a first adaptation circuit 309 and a network controller 313. The first adaptation circuit 309 will be described in detailed below along with its associated second adaptation circuit 315. The network controller 313 performs various networking functions, such as sending and receiving data from the networks and converting the signaling and user-plane packets into IP frames and vice versa while receiving. The network controller 313 performs other functions such as routing, firewall, separation of signaling and media data packets.

The first and second adaptation circuits 309, 315 are signaling converters that perform incoming call handling functions and outgoing call handling functions. The incoming call handling functions include signaling converter works in conjunction with network processor to separate the signaling and media information. After separating the signaling information from the media information, the adaptation circuits 309, 315 convert the IP frames into cellular protocol formatted messages, as described above. The cellular formatting involves processing the messages in one or more layers, such as radio resource and call control and management layers. After the conversion, the adaption circuits 309, 315 provides adaptation in association with the digital-analog adaptation layer to various devices by translating the cellular signaling messages into a corresponding signal format that the devices may recognize, for example, analog PSTN signaling (voltage variations) for Analog PSTN terminals, digital ISDN signaling (such as Q.931) for ISDN terminals, and DTMF tone processing.

The first and second adaptation circuits 309, 315 provide incoming call handling functions as well. In cases where a digital device sends media information and signaling information together, the signaling information is from separated from the media information. Also, signals from the non-cellular devices 201 (voltage variations and/or multi-frequencies tones) may be converted to cellular call control equivalent messages, and DTMF tone detection and processing may be performed. Signals from the devices may then be formatted into a cellular signaling scheme, as described above, by processing through the various layers of call control and radio management. The formatted cellular signaling messages are then tunneled into the network using IP frames.

In order for a non-cellular device 121 to communicate with the cellular core network 109, the non-cellular device 121 must be associated with a cellular identification number. For one embodiment, a subscriber identification module (SIM), which stores the identification number, may be provided to the adapter 123 so that it may be uploaded to the cellular core network 109 and/or access network controller 115 via the IP NET 117. For another embodiment, the adapter 123 may register with the cellular core network 109 and/or the access network controller 115 via the IP NET 117, so that the cellular core network and/or the access network controller may assign an identification number associated with the non-cellular device 121. For yet another embodiment, regardless of whether the identification number is provided by a SIM or assigned by the network, the identification number may be associated with a group of non-cellular devices wired to a common gateway 125. For this third embodiment, one or more non-cellular devices 201 may be wired to the common gateway 125 as well as the adapter 123.

As described above, a non-cellular device 121 may be communicate with a cellular core network 109 and/or an access network controller 115 via an adapter 123 communicating with a packet data network, such as IP NET 117. The adapter 123 may be coupled to, or integrated with, the non-cellular device 121 and/or the gateway 125. In providing this connection to the cellular core network 109 and/or the access network controller 115, the non-cellular device 121 may benefit from cellular services provided by the cellular core network and/or the access network controller, such as those services managed by the service manager 119. These cellular services include, but are not limited to messaging services, such as email service, short messaging service, instant messaging service, audio/image/video messaging services, and multimedia messaging service.

For example, analog PSTN devices may use Multi-Frequency pulse to send the dialed digits in the media channel. A special key sequence may be used and set the mode of the signaling converter to send messaging services. In this special mode, the media signals may be converted into text and sent as messages. The text may be played back to a user before sending. Similarly, messages may be received by the adaptation circuits 309, 315 and displayed as alerts in which part of the text message may be appended to the caller line Identification. If the user is interested in the entire text, then the user may put the non-cellular device 121 in the special mode and then receive text-to-voice converted messages. Non-cellular devices 121 that support ISDN (Q.931) signaling may send and receive messages using the user-user information element in Layer-3 messages and display element in the Q.931 messages. To send a message, the keypad protocol or voice-to-text schemes may be used with ISDN terminals.

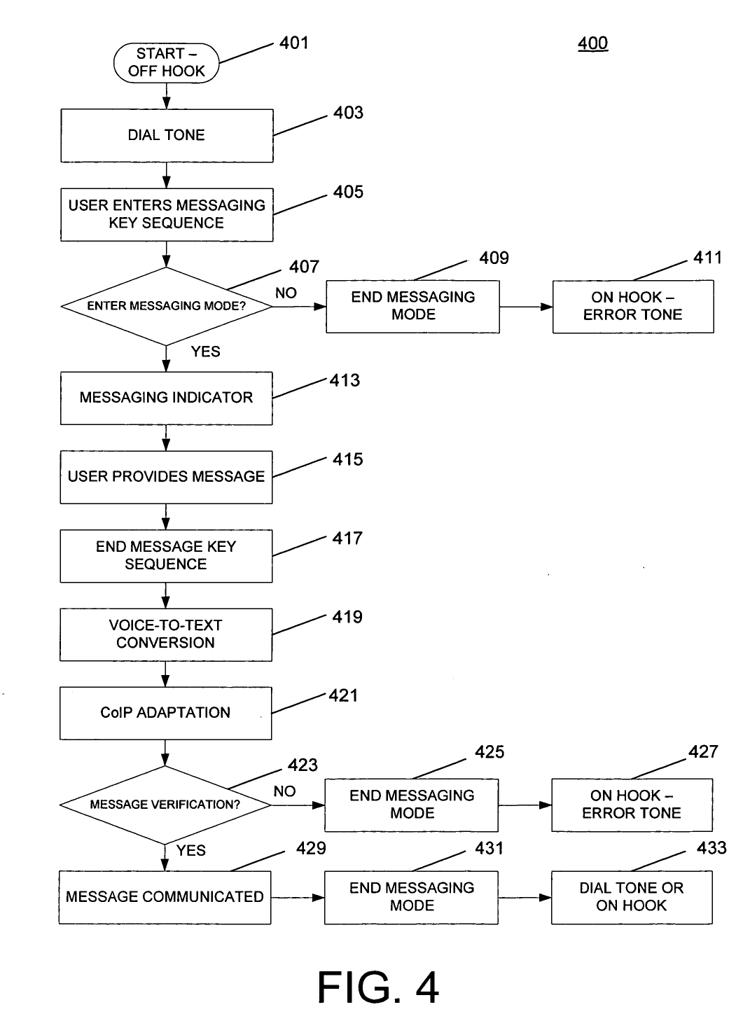

FIG. 4 is a flow diagram representing an exemplary message sending operation 400 of the adapter 123 from a non-cellular device to a cellular network. Initially, the operation 400 begins at step 401 in response to an operation activation. For example, the adapter 123 may detect that the non-cellular device 121 has changed state from an on-hook mode to an off-hook mode. As a result, the adapter 123 may detect a dial tone at step 403. Next, it may be necessary to inform the adapter 123 that the non-cellular device 121 will be operating in a messaging mode. For example, a user may enter a messaging key sequence at a keypad of the non-cellular device 121, which is provided to the adapter 123, at step 405, and the adapter may compare the message key sequence with data stored in its memory to determine whether it- should operate in a messaging mode at step 407. If the messaging key sequence indicates that the adapter 123 should not enter a messaging mode, then the adapter may terminate any messaging mode or any attempt to initiate a messaging mode at step 409 and terminate the operation 400 at step 411. Optionally, an error signal may be provided to the non-cellular device 121.

If the messaging key sequence indicates that the adapter 123 should enter a messaging mode, then the adapter may provide a messaging indicator to the non-cellular device 121 and/or an output device of the adapter at step 413. The adapter then receives a message from the non-cellular device at step 415, and continues to receive the message until an end to the message is identified at step 417, i.e., receiving a signal from the non-cellular device includes identifying a termination point of the message. If the message is received in voice format, the adapter 123 may convert the message from an audio format to a text format at step 419. Thereafter, the adapter 123 performs a CoIP adaptation operation which adapts the message from a non-cellular protocol of the non-cellular device to a cellular protocol transportable by one or more data packets of a packet data network at step 421. The one or more data packets are based on an internet protocol for transport over the packet data network, such as IP NET 117.

At this point, the adapter 123 may perform a message verification operation at step 423 to determine whether the message is ready to be communicated to the cellular network. If the adapter 123 determines that the message is not ready to be communicated, then the adapter may terminate the messaging mode at step 425 and terminate the operation 400 at step 427. Optionally, an error signal may be provided to the non-cellular device 121 at step 427. If the message is ready to be communicated or if the verification is not performed, then the adapter 123 directs the message to the cellular network at step 429. Thereafter, the adapter 123 may terminate the messaging mode at step 431 and terminate the operation 400 at step 433.

FIG. 6 is a flow diagram representing an exemplary message receiving operation 500 of the adapter 123 from a cellular network to a non-cellular device. Initially, the operation 400 begins at step 501 in response to an alert indicator. For example, the adapter 123 may detect that the cellular network has communicated an alert signal directed to the non-cellular device 121. As a result, the adapter 123 may detect an off hook condition of the non-cellular device 121 at step 503. If the adapter 123 determines that the non-cellular device 121 is not off hook, then the adapter may store any message that it subsequently receives in memory at step 505 and terminate the operation 500 at step 507. The message may be stored in a predetermined memory location of the adapter 123 or a removable module coupled to the adapter, such as a SIM. If the adapter 123 determines that the non-cellular device 121 is off hook, then the adapter 123 may operate in a messaging mode and provide a messaging indicator to the non-cellular device 121 and/or an output device of the adapter at step 509. The adapter 123 then receives a message from the cellular network via the gateway 125 at step 511. The adapter 123 may continues to receive the message until an end to the message is identified at step 417, i.e., receiving a signal from the non-cellular device includes identifying a termination point of the message. Next, the adapter 123 may determine whether to store the message in memory at step 513. If the adapter 123 determines that the message should be stored, then it may store the message in memory at step 515 and terminate the operation 500 at step 517. The message may be stored in a predetermined memory location of the adapter 123 or a removable module coupled to the adapter, such as a SIM.

The adapter 123 then performs a CoIP adaptation operation which adapts the message from the cellular protocol transportable by one or more data packets of a packet data network to a non-cellular protocol of the non-cellular device 203 at step 519. The one or more data packets are based on an internet protocol for transport over the packet data network, such as IP NET 117. If the message is received in voice format, the adapter 123 may convert the message from a text format to an audio format at step 521. Then, the adapter 123 may playback the message by forwarding it to the non-cellular device 121 at step 523. After the message is played, the adapter 123 may whether the message should be stored at step 525. If the adapter 123 determines that the message should be stored, then it may store the message in memory at step 527 and terminate the operation 500 at step 529. The message may be stored in a predetermined memory location of the adapter 123 or a removable module coupled to the adapter, such as a SIM. Regardless of whether the message is stored, the operation 500 terminates the operation at step 531.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An adaptation apparatus for providing access to cellular services of a cellular network for a non-cellular device via a packet data network comprising:
a cellular module configured to convert between cellular protocol information of a cellular network and non-cellular protocol information of the non-cellular device; and
a packet data circuit configured to adapt outgoing cellular protocol information, destined for the cellular network, for transport by the packet data network, and identify incoming cellular protocol information received from the cellular network via the packet data network.

2. The adaptation apparatus of claim 1, wherein the cellular module comprises:
a cellular signaling module configured to control and manage call signaling; and
a cellular codec module configured to encode and decode call data.

3. The adaptation apparatus of claim 1, wherein the packet data module comprises:
a cellular over IP signaling module configured to adapt a signaling portion of the cellular protocol information for transport over the packet data network; and
a media and transport layer packetization configured to adapt a data portion of the cellular protocol information for transport over the packet data network.

4. The adaptation apparatus of claim 1, further comprising an identification module including information associated with a cellular subscriber of the cellular network.

5. The adaptation apparatus of claim 1, wherein the cellular protocol information is formatted for cellular-based communication.

6. A method for sending information from a non-cellular device to a cellular network comprising:
receiving non-cellular protocol information from the non-cellular device;
converting the non-cellular protocol information to cellular protocol information;
adapting the cellular protocol information to one or more data packets for transport by a packet data network; and
directing the one or more data packets to the cellular network via the packet data network.

7. The method of claim 6, wherein receiving non-cellular protocol information from the non-cellular device includes receiving a media message from the non-cellular device, the media message being one of a text message and a multimedia message.

8. The method of claim 6, further comprising operating in a messaging mode in response to receiving a messaging signal from the non-cellular device.

9. The method of claim 6, further comprising indicating a messaging mode to the non-cellular device.

10. The method of claim 6, wherein receiving non-cellular protocol information from the non-cellular device includes identifying a termination point of the non-cellular protocol information.

11. The method of claim 6, further comprising converting one of the non-cellular protocol information and the cellular protocol information from an audio format to a text format.

12. A method for receiving information at a non-cellular device from a cellular network comprising:
receiving cellular protocol information in the form of one or more data packets from the cellular network via a packet data network;
adapting the cellular protocol information to a non-packetized form;
converting the cellular protocol information in the non-packetized form to non-cellular protocol information; and
directing the non-cellular protocol information to the non-cellular device.

13. The method of claim 12, wherein receiving cellular protocol information in the form of one or more data packets from the cellular network via a packet data network includes receiving a media message in the form of one or more data packets from the cellular network via the packet data network, the media message being one of a text message and a multimedia message.

14. The method of claim 12, further comprising:
receiving an alert indicator from the non-cellular device; and
detecting an operation activation of the non-cellular device in response to receipt of the alert indicator by the non-cellular device.

15. The method of claim 12, further comprising indicating a messaging mode to the non-cellular device in response to receiving a messaging signal form the cellular network.

16. The method of claim 12, further comprising converting one of either the cellular protocol information and the non-cellular protocol information from a text format to an audio format.

17. The method of claim 12, further comprising determining whether to store any incoming information in a memory.
